(19) United States
(12) Patent Application Publication
(10) Pub. No.: US 2011/0236704 A1
(43) Pub. Date: Sep. 29, 2011

(54) PROCESS FOR FABRICATING A LAYER OF AN ANTIFERROMAGNETIC MATERIAL WITH CONTROLLED MAGNETIC STRUCTURES

(76) Inventors: Antoine Barbier, Chilly Mazarin (FR); Odile Bezencenet, Paris (FR); Daniel Bonamy, Orsay (FR)

(21) Appl. No.: 13/128,721

(22) PCT Filed: Oct. 13, 2009
(86) PCT No.: PCT/FR09/51950

§ 371 Date: Jun. 10, 2011

(30) Foreign Application Priority Data
Nov. 12, 2008 (FR) 0857646

(51) Int. Cl. H01F 10/00; B05D 3/00; B32B 9/00

(52) U.S. Cl. 428/469; 427/547; 428/693.1

(57) ABSTRACT

A process for fabricating an antiferromagnetic layer includes depositing on a substrate a first layer with a sufficient thickness to establish a specific magnetic order from among one of the following orders, ferrimagnetic, ferromagnetic, paramagnetic, diamagnetic; after establishing the ferrimagnetic, ferromagnetic, paramagnetic or diamagnetic order, applying a magnetic field with sufficient amplitude and duration to shift walls of the magnetic domains of the first layer from a first statistical distribution to a second statistical distribution, the second statistical distribution presenting a minimum magnetic domain size strictly greater than the minimum magnetic domain size of the first statistical distribution and; for a given area, magnetic domains in which the perimeter is greater than that of domains from the first statistical distribution; and depositing on the first layer whose magnetic domain walls have been shifted, a second layer of an antiferromagnetic material in which at least one of the components of material of the first layer may be integrated by diffusion during growth.

The present invention relates to a process for fabricating antiferromagnetic layers, and more particularly those that are used in spintronics.

The materials owe their magnetic properties to the fact that certain atoms have one or more atomic sublayers having a single electron whose magnetic spin is not cancelled out by the opposed spin of another electron. Most of these materials have several single electrons, for which the algebraic sum of the elementary magnetic moments is not zero.

Four main categories of magnetic materials may be distinguished:
ferromagnetic and ferrimagnetic materials;
diamagnetic materials;
paramagnetic materials;
antiferromagnetic materials.

The first category is formed by ferromagnetic and ferrimagnetic materials. The latter are characterized in that the magnetic moment of an atom is strongly coupled with the magnetic moment of neighboring atoms by exchange coupling, which tends to align in a same direction the magnetic moments of all the atoms inside a same magnetic domain (called Weiss domain). For ferromagnetic materials, each of these atoms magnetized in a same direction has the same magnetization intensity. The magnetic behavior of ferrimagnetic materials is very close to that of ferromagnetic materials. Here also, the magnetic moments of atoms of a same domain are in a same direction, but in ferrimagnetism, the peripheral electrons are distributed differently between the two spins when one passes from one atom to another, such that the magnetization intensity varies according to each atom. However, in the two cases (ferrimagnetic and ferromagnetic), the existence of magnetic domains and their formation are governed by the same laws: Consequently, either ferrimagnetic materials or ferromagnetic materials will be referred to in the rest of the description.

When they are not saturated but are in a disordered state or are weakly magnetized, the ferromagnetic materials are thus constituted of a plurality of magnetic domains (Weiss domains) separated between each other by magnetic walls (for example, Bloch walls): A magnetic domain is a magnetic microstructure in which the magnetic moments are all oriented in a same direction. Magnetic domains have irregular shapes, whose dimensions are on the order of some hundreds of nanometers, or even a micron, and the magnetization is very intense. The magnetic orientations of two juxtaposed domains are initially poorly coupled, which causes magnetic noise when a spin current flows through the material. In fact, each electron traversing a magnetic domain undergoes a spin transfer depending on the difference between its magnetic orientation and that of the domain under consideration.

For hard layers of ferromagnetic material, the algebraic sum of magnetic moments of all domains has a fixed non-zero value determining its macroscopic magnetization. Subjected to an external magnetic field, these materials align their magnetic domains in the direction of the external field. The more intense this field, the more numerous the magnetic domains that orient themselves along its direction, until saturation, that corresponds to the alignment of all magnetic domains in the direction of the external field. Hard ferromagnetic materials have an atomic structure that makes a random reorientation of magnetic domain magnetizations after removal of the external magnetic field difficult. All of these magnetic properties reversibly disappear under the effect of thermal agitation beyond the Curie temperature. It will be noted that the stability of these hard layers may be ensured by its form and/or by exchange coupling with an antiferromagnetic layer.

The second category of magnetic materials is constituted of diamagnetic materials characterized in that almost all of the atoms do not have an atomic sublayer with a single electron; For each sublayer, the magnetic moment created by an electron is thus cancelled out by the magnetic moment of the electron matching it. The resulting magnetic moment for each atom has an initially random direction, but zero intensity. No magnetic coupling exists between two neighboring atoms. However, when such a material is subjected to an external magnetic field, the magnetic moment of each atom tends to very slightly orient itself in the opposite direction from this field, progressively forming, as the field intensity increases, magnetic domains. Their magnetization intensity remains much less than the magnetization of a ferromagnetic material; moreover, it is not possible to reach saturation.

The third category relates to paramagnetic materials that are characterized in that their atoms have atomic sublayers with at least one single electron. However, no coupling between two neighboring atoms or long distance magnetic order exists. When they are subjected to an external magnetic field, the magnetic moment of each atom tends to very slightly orient itself in the direction of this field, progressively forming, as the field intensity increases, magnetic domains. Their magnetization intensity remains much less than the magnetization of a ferromagnetic material and no remanence is observed after exposure to an external field. Again, reaching saturation is thus not at all possible.

The fourth category of magnetic materials is that of antiferromagnetic materials. Their atoms have saturated layers, whose spin magnetic moments cancel themselves two by two. Their magnetic moment has a completely ineffective intensity, to the point of cancelling any interaction with an external magnetic field. Nevertheless, they have an antiferromagnetic structure characterized by the ordering into two subnetworks with opposed magnetization, whose result is zero. Nevertheless, the subnetworks are organized into magnetic domains, called. Néel domains, that separate the regions where the antiferromagnetic order has nucleated according to crystallographic orientations that are different as well as equivalent in symmetry. Without intervention other than the growth of the material, these domains are naturally expected to be smaller (by one to two orders of magnitude) than the Weiss domains of ferromagnetic materials. In the particular case of thin layers (from 1 to 100 nm), these domains are delimited between each other by the fact that a same domain presents at its outer surface one of the magnetization subnetworks, oriented in a certain direction, the atomic layer immediately inside this domain being clearly constituted of the subnetwork with opposed magnetization (same direction and opposite direction). This ordering exists below the Néel temperature and reversibly disappears above this temperature to give way to a slight paramagnetism or absence of magnetic order. These Néel domains are at the origin of magnetic noise when a spin current flows through the material, in a comparable manner to Weiss domains for ferro- or ferrimagnetic materials.

Some known techniques enable antiferromagnetic layers to be obtained in which the atomic layer per unit of area (external) corresponds to a magnetized network in one direction, the atomic layer immediately deeper (internal) clearly corresponds to the magnetized network in the opposite direction. Such an arrangement enables the atoms from the external layer per unit of area to establish a magnetic exchange action with the atoms from a material placed in immediate contact. By placing a ferromagnetic layer in contact, one may impose, by exchange coupling, the magnetic direction of this ferromagnetic layer. Since the antiferromagnetic layer is totally insensitive to the external magnetic field, it thus locks the orientation of the ferromagnetic layer. In this way is obtained the ferromagnetic/antiferromagnetic coupling used to produce the “hard layers” mentioned above, at a fixed magnetization direction, in giant magneto resistance elements, spin valves, magnetic storage and, more generally, any spintronics.

Whatever the magnetic material, the presence of magnetic domains (Weiss, Néel, etc.) separated by walls is observed; these magnetic microstructures will subsequently be designated by the generic term magnetic domain.

As already mentioned above, the magnetic domains, whatever they are, are at the origin of a noise (Barkhausen noise) induced by the displacement of walls of these domains. Consequently, having magnetic layers whose magnetic domains are as big as possible is useful in spintronics, in order to limit this noise. One way to reduce the number of small domains consists of applying a magnetic field to the magnetic material that is sufficiently strong such that the material contains practically no more walls and is monodomain. However, this solution is not applicable to antiferromagnetic material layers; their lack of sensitivity to the external magnetic field does not allow them to act on domain dimensions.

One known solution to enlarge the Néel domains of an antiferromagnetic layer consists of using the following process:
choosing ferromagnetic and antiferromagnetic materials such that the Néel temperature of the antiferromagnetic material is lower than the Curie temperature of the ferromagnetic material;
fabricating an antiferromagnetic layer;

placing this antiferromagnetic layer in very close contact with a ferromagnetic layer;
causing the assembly to undergo annealing at a temperature higher than the Néel temperature of the antiferromagnetic layer and lower than the Curie temperature of the ferromagnetic material, by applying, once at this temperature, an external magnetic field capable of enlarging the magnetic domains; Preferentially, magnetically saturating the ferromagnetic layer to have a single magnetic domain.

Nevertheless, this process presents the following disadvantages:
the thermal treatment may cause the interdiffusion of atoms between layers, leading to significant deterioration of the junction characteristics. To limit this phenomenon, depending on the thermodynamic laws, all antiferromagnetic materials at high Néel temperature, which are precisely those that confer the greatest stability to the final spintronics device, and because of this must be preferred, should be systematically eliminated; Typically, antiferromagnetic materials such as Fe₂O₃ are not usable insofar as they present a Néel temperature of approximately 650° C. Annealing at a temperature on the order of 700° C. (beyond the Néel temperature of the antiferromagnetic layer) with a metallic layer above the antiferromagnetic layer would lead to technologically unacceptable inter-diffusions.
the layer assembly is subjected to the same thermal treatment, which is contraindicated for certain applications. In fact, at the end of this treatment, a magnetic monodomain is obtained; on the other hand, if one wishes to obtain domains that are sufficiently large but different, it is then necessary to cut the individual junctions by lithography at the end of the treatment;
annealing, generally carried out between 200 and 300° C. for 30 to 60 minutes, may generate recrystallizations, that lead to unacceptable inhomogeneities, particularly from the point of view of magnetic properties. This may interfere with certain applications such as MRAM type magnetic storage where many junctions must have identical magnetic properties;
this process is used with substrates that are generally chosen to be inert with relation to the metals; On the other hand, the migration of doping elements caused by annealing makes its application extremely delicate for substrates such as silicon, that would be particularly interesting for integration with electronic components.

In addition, control of this process on magnetic domains remains limited.

In conclusion, the known process described above has an extremely limited utilization and is hardly applicable to many spintronics circuits.

In this context, the object of the present invention is to provide a process for fabricating an antiferromagnetic layer allowing small size Néel domains to be eliminated and to significantly increase the size of the remaining Néel domains while getting rid of the limitations mentioned above (interdiffusion, inapplicability of the process with antiferromagnetic materials having a too-high Néel temperature, recrystallizations, homogeneity of the treatment, inapplicability to substrates such as silicon).

For this purpose, the invention proposes a process for fabricating an antiferromagnetic layer comprising the following steps:
deposition on a substrate of a first layer with a sufficient thickness to establish a given magnetic order from among one of the following orders:
   ferrimagnetic,
   ferromagnetic,
   paramagnetic,
   diamagnetic;
after establishing said ferrimagnetic, ferromagnetic, paramagnetic or diamagnetic order, application of a magnetic field with sufficient amplitude and duration to shift the walls of the magnetic domains of said first layer from a first statistical distribution to a second statistical distribution, said second statistical distribution presenting:
   a minimum magnetic domain size strictly greater than the minimum magnetic domain size of the first statistical distribution and;
   for a given area, magnetic domains in which the perimeter is greater than that of domains from the first statistical distribution;
deposition, on said first layer whose magnetic domain walls have been shifted, of a second layer of an antiferromagnetic material in which at least one of the components of material of said first layer may be integrated by diffusion during growth.

Antiferromagnetic material in which at least one of the components of material of said first layer may be integrated by diffusion during growth is understood to refer to:
either a material with the same chemical formula as that of the material of the first layer;
or a material with a chemical formula partially including the chemical formula of the first layer; Fe₂O₃ may be cited as an example of a component from a first ferromagnetic layer γ-Fe₂O₃, and as a second antiferromagnetic layer LaFeO₃: It is clear that the Fe₂O₃ groups then diffuse in the LaFeO₃ antiferromagnetic layer. Fe may also be cited as the first layer and FeMn as the second antiferromagnetic layer: In this case the Fe atoms diffuse in the FeMn layer.

It is noted that the external magnetic field applied must have a certain amplitude to obtain the shifting of domains; Typically, during magnetization of a ferro- or ferrimagnetic material, when a magnetic field applied has a too-low amplitude, the response of the material may be reversible. In this case, the spins may follow, at least partially, the external field applied but the domain walls do not move. When the magnetic field is cut, the spins return to their initial state and nothing has changed. Consequently, according to the invention, it is necessary to apply a magnetic field exceeding this phenomenon to obtain shifting of the walls.

Just as with the magnetic field, time necessary for switching domains is understood to refer to the time necessary so that the shifting of walls endures in a stable position after elimination of the magnetic field. If a magnetic field is applied for a too-short time and/or with a too-weak magnetic field, the modifications will be reversible. Wall shifting is typically done at the millisecond scale, a magnetic field with higher amplitude tending to slightly reduce this value. Therefore, one must leave the present field for the time necessary so that the walls are effectively shifted, and in the case of a short pulse followed by a Larmor precession, add the time necessary for stabilizing the electronic spins to the wall shifting time.

The amplitude of the field and the application time of this field depend on the material. In general, the reversible magnetization zone must be overcome.

Thanks to the invention, the antiferromagnetic layer will repeat the statistical distribution of domains from the first magnetic layer, which will have enlarged magnetic domains at the time of deposition of the first atomic layers of antiferromagnetic layer, these first layers being in a sufficient number so as to establish the ferromagnetic order. The antiferromagnetic order is established over great distances with relation to other magnetic (several nanometers) or structural (less than the nanometer) orders. The growth of the antiferromagnetic layer is carried out from a first layer, either ferrimagnetic or ferromagnetic, or paramagnetic or diamagnetic: The antiferromagnetic order is established following a sufficient thickness of ferri, ferro, para or diamagnetic material. In all cases, this first layer must have a sufficient thickness so that the ferri, ferro, para or diamagnetic order is established. This order generally corresponds to the thickness of at least three or four atomic layers (typically on the order of a nanometer). The process from the invention consists of intervening at a stage that is sufficiently early in the growth of the antiferromagnetic layer in order to avoid problems from the prior art. When the antiferromagnetic order is not yet established, it may be manipulated by modifying the magnetic domains from the first layer (initial layer) by application of an external magnetic field (permanent or not permanent). In fact, the applicant had the surprise of observing that the statistical distribution of the antiferromagnetic layer repeats the statistical distribution of the initial layer. Consequently, the antiferromagnetic state of the antiferromagnetic layer is modified by applying a magnetic field before the transition to the antiferromagnetic order and by modifying the domains of the initial layer. Thus, the size, shape or statistical distribution of the antiferromagnetic Néel domains may be controlled without resorting to annealings or post-processing methods. The process according to the invention thus enables having recourse in spintronics to antiferromagnetic materials with a high Néel temperature and to ferromagnetic materials coupled by exchange with Curie temperatures lower than the Néel temperature of the antiferromagnetic layer.

It should be noted that the magnetic field is only applied from the time when the ferro, ferri, para or diamagnetic order is established. Thus, the process according to the invention totally differs from known processes to influence the formation of metallic films, magnetic or not, by using a magnetic field in a plane parallel to the surface of the substrate aiming to prevent high-energy electrons coming from a plasma source from bombarding and thus altering the surface of the film during its development: These processes absolutely do not aim to influence the distribution of magnetic domains by application of a magnetic field to an initial layer in which the magnetic order is established. These processes contribute even less to enabling an antiferromagnetic layer to grow on the initial layer and to repeating the statistical distribution of magnetic domains of the initial layer.

The method according to the invention may also present one or more of the characteristics below, considered individually or according to all technically possible combinations:
said magnetic field is applied for a time at least equal to that required for the specified switching of said magnetic domains;
the antiferromagnetic material of said second layer has the same chemical formula as that of the material from said first layer;
said first layer is a ferrimagnetic or ferromagnetic layer, and said magnetic field application time is at least equal to the time necessary to switch said domains;
said first layer is made in a ferrimagnetic γ-Fe₂O₃ material such that the antiferromagnetic state of said second layer of α-Fe₂O₃ is modified by applying a magnetic field on said first layer before the transition to the antiferromagnetic order;
said first layer is a paramagnetic or diamagnetic layer, said application time being greater than or equal to the time necessary for establishing the antiferromagnetic order of said second layer;
said magnetic field is applied after a thickness of said first layer greater than or equal to the thickness necessary so that the magnetic order of said first layer is established;
said magnetic field is applied after a thickness of said first layer greater than or equal to a thickness on the order of two to three atomic layers;
said magnetic field is applied according to a direction parallel to a crystalline anisotropy axis of the material of said first layer;
said magnetic field application is done outside of the deposition chamber in which said process is implemented;
said magnetic field application is done inside the chamber in which said process is implemented via magnetic means such as at least one permanent magnet or at least one vacuum coil arranged directly in said chamber;
the deposition of said first and second layer is done in a growth chamber by molecular beam epitaxy with a pressure, during deposition, of less than or equal to 10⁻⁸ bar and preferentially less than or equal to 10⁻⁹ bar;
the deposition temperature is between ambient temperature and 450° C.;

the growth of said first layer is carried out on a substrate cleaned of any contamination;
the deposition of said first and second layers is done by utilizing one of the following techniques:
   deposition by laser ablation;
   molecular beam epitaxy;
   deposition by chemical means such as chemical deposition in CVD vapor phase or electrochemistry;
said substrate utilized is an Al₂O₃(0001) or Pt(111) type substrate;
said magnetic field applied is a field sufficient for causing the shifting of magnetic walls and is limited at the most to the saturating field value for the material of said first layer;
said magnetic field is not uniform in space and presents at least one first region subjected to a first magnetic field value uniform in intensity and direction, and at least one other magnetic field value uniform in intensity and direction, creating a structuring of the space in magnetically distinct zones;
a magnetic field pulse is applied that is sufficiently intense to move the magnetic spins of electrons apart from their initial position such that, after elimination of the magnetic field, these spins are realigned by a Larmor precession in a new orientation determined by the short magnetic field pulse.

Another object of the present invention is a magnetic structure comprising at least one antiferromagnetic layer obtained by the process according to the invention.

Advantageously, the magnetic structure according to the invention comprises at least one ferromagnetic layer deposited on said antiferromagnetic layer and in which the configuration of magnetic domains is identical to that of said antiferromagnetic layer.

Other characteristics and advantages of the invention will clearly emerge from the description given below, for indicative and in no way limiting purposes, with reference to the attached figures, among which:

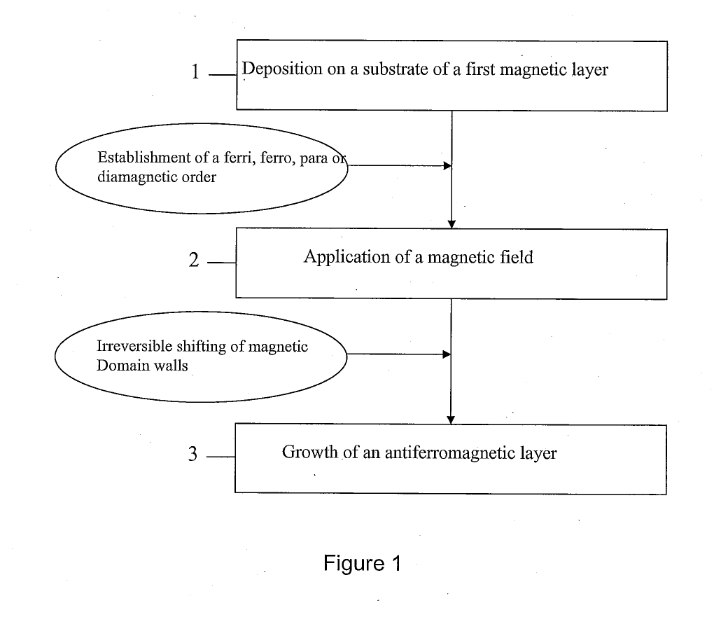

FIG. 1 illustrates the different steps Of the process according to the invention;

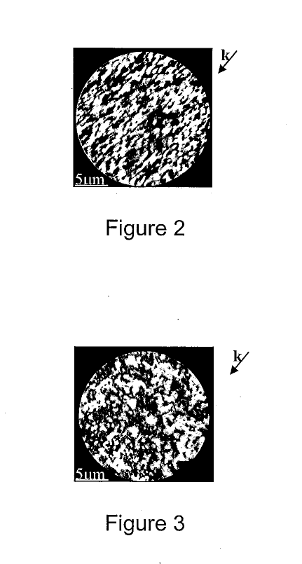

FIG. 2 represents an image of magnetic domains observed on a ferrimagnetic layer with a thickness of 2 nm of γ-Fe₂O₃;

FIG. 3 represents an image of magnetic domains observed on an antiferromagnetic layer with a thickness of 10 nm of α-Fe₂O₃;

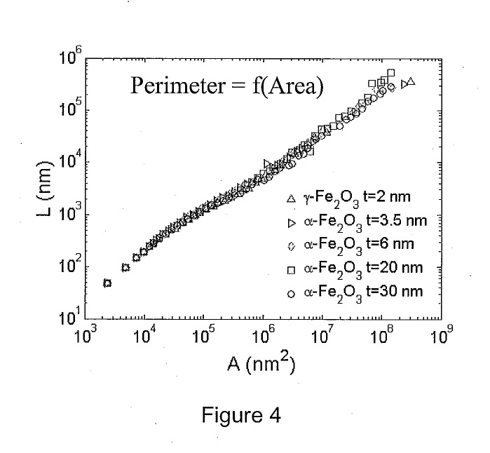

FIG. 4 represents the statistical evolution of the perimeter of ferri- or antiferromagnetic domains of Fe₂O₃ with a thickness of 2, 3.5, 6, 20 and 30 nm according to the area of these domains;

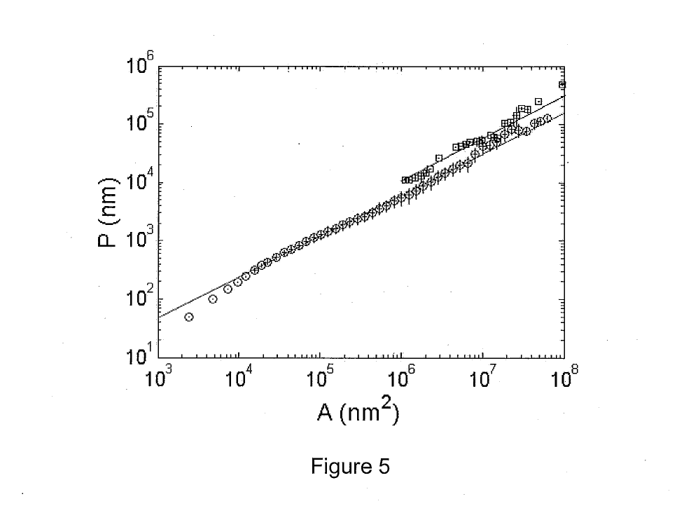

FIG. 5 represents the statistical evolution of the perimeter of magnetic domains according to the area of these domains for two antiferromagnetic layers of α-Fe₂O₃ with a thickness of 10 nm obtained respectively with and without magnetic field treatment in the early phase of the growth of the process according to the invention;

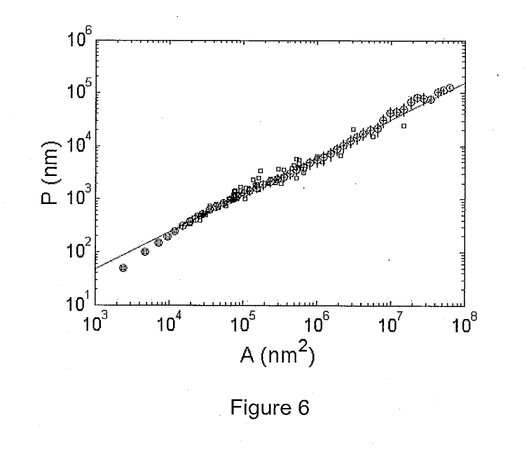

FIG. 6 represents the statistical evolution of the perimeter of magnetic domains according to the area of these domains for different antiferromagnetic layers of Fe₂O₃ and an antiferromagnetic layer of LaFeO₃ with a thickness of 40 nm;

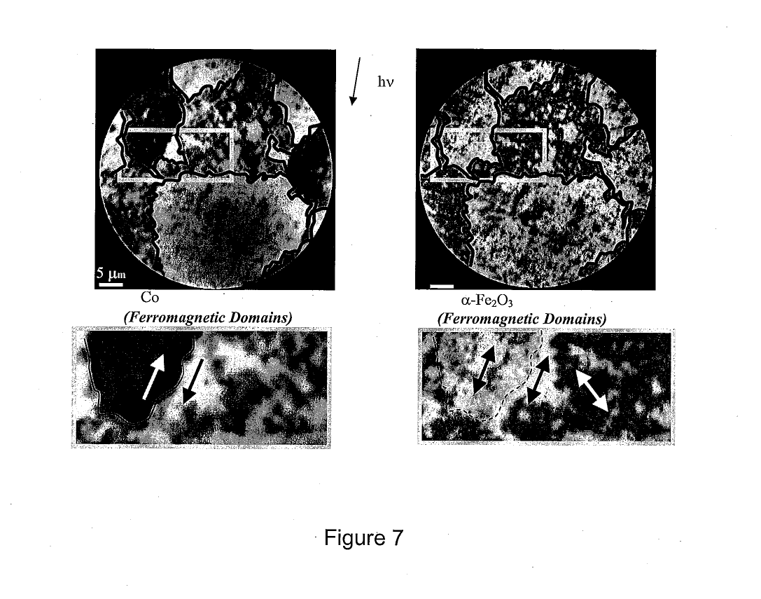

FIG. 7 represents an image Of ferromagnetic domains from a layer of 2 nm of Co and domains from an antiferromagnetic layer of Fe₂O₃ with a thickness of 20 nm obtained by the process according to the invention.

In all figures, common elements bear the same reference numbers.

The process according to the invention advantageously utilizes the surprising observation by the applicant that the statistical distribution of magnetic domains is identical in a ferrimagnetic film of γ-Fe₂O₃, with a thickness of less than 3 nm, and in an antiferromagnetic film of α-Fe₂O₃ with a thickness greater than 3 nm.

This phenomenon is first illustrated by FIGS. 2 and 3.

FIG. 2 represents an image of magnetic domains observed on a ferrimagnetic layer with a thickness of 2 nm of γ-Fe2O3. The image is performed by spectromicroscopy from a source of circularly polarized monoenergetic photons of energy close to absorption thresholds L2 or L3 of Fe; The image results from the weighted difference of images observed for right and left circular polarizations. The direction of incident photons is indicated by an arrow on the image. The white zones from the image represent magnetic domains with magnetic moments oriented following the direction of the incident photons. The black zones represent magnetic domains with magnetic moments opposed to the direction of the incident photons. The grey zones represent magnetic domains in which the direction of magnetic moments is situated between that of the white and black zones.

FIG. 3 represents an image of magnetic domains observed on an antiferromagnetic layer with a thickness of 10 nm of α-Fe₂O₃ obtained after growth on a ferrimagnetic film of γ-Fe₂O₃. As we have already mentioned above, the antiferromagnetic order necessitates rather large scales to be established and the growth of an antiferromagnetic layer is carried out via the passage by a first layer with a different order (ferrimagnetic, ferromagnetic, diamagnetic or paramagnetic). According to a preferential embodiment, the first layer is a ferrimagnetic layer. In the present case, the ferrimagnetic phase γ-Fe₂O₃ is stable up to a thickness of 3.5 nm before switching to the α-Fe₂O₃ phase that is antiferromagnetic. With a same chemical formula (Fe₂O₃), the invention thus passes from a ferrimagnetic phase to an antiferromagnetic phase. The image is performed by spectromicroscopy from a source of linearly polarized monoenergetic photons of energy close to absorption thresholds L2 or L3 of Fe; The image results from the weighted difference of images observed for horizontal and vertical linear polarizations. The direction of incident photons is indicated by an arrow on the image. The white zones from the image represent magnetic domains with magnetic moments parallel or antiparallel to the direction of the incident photons. The grey or black zones represent magnetic domains with magnetic moments substantially perpendicular to the direction of the incident photons.

The person skilled in the art observes in the two images from FIGS. 2 and 3 that the magnetic domain walls are substantially identical.

This surprising phenomenon is confirmed by FIG. 4 that represents the statistical evolution of perimeter L of the ferri- or antiferromagnetic domains of layers of Fe₂O₃ with thicknesses t equal to 2, 3.5, 6, 20 and 30 nm according to the area A of these domains. In all the rest of the description, magnetic domain perimeter is understood to refer to the length of the boundary of the magnetic domain. More precisely, the layer with a thickness of 2 nm is a ferrimagnetic γ-Fe₂O₃ layer and the layers with thicknesses of 3.5, 6, 20 and 30 nm are antiferromagnetic α-Fe₂O₃ layers. The statistical distribution of magnetic domains is identical in the ferrimagnetic γ-Fe₂O₃ layer with a thickness of 2 nm and in the antiferromagnetic α-Fe₂O₃ layers with a thickness greater than or equal to 3.5 nm. In other words, the percentage of domains distributed following certain classes of dimensions is identical for the ferrimagnetic material and the antiferromagnetic material. This result is valid whatever the thickness of the antiferromagnetic samples.

The statistical distribution of domain sizes obeys, in the two cases, the statistical laws of a random field Ising model, typical of ferromagnetic materials. The fractal dimension obtained from domain images is 1.89±0.02 and the roughness coefficient is 0.60±0.04, which corresponds to the exponents expected in the hypothesis of a ferromagnetic domain propagation equation (governed more precisely by a Kardar-Parisi-Zhang type equation). That said, seeing boundaries of antiferromagnetic domains responding to a model designed for physical propagation phenomena was not expected.

The process according to the invention advantageously utilizes identical statistical distributions between the antiferromagnetic layer and the initial layer on which it grows.

FIG. 1 illustrates the different steps 1 to 3 of the process according to the invention. In its most general form, the invention consists of a process of fabricating an antiferromagnetic layer in which the magnetic domains are determined by the application of an external magnetic field.

This process thus comprises a first step 1 consisting of depositing, on a substrate, a first magnetic layer (ferri, ferro, para or diamagnetic).

The second step 2 consists, after depositing with a thickness sufficient so that the magnetic order (ferri, ferro, para or diamagnetic) of the material of the first layer is established, i.e., in practice at least three or four atomic layers, of applying an external magnetic field with sufficient amplitude to cause the shifting of magnetic domain walls of the first layer for a time at least equal to the switching time of these domains. In other words, a magnetic field is applied with sufficient amplitude and duration to shift the walls of the magnetic domains of the first layer from a first statistical distribution to a second statistical distribution, the second statistical distribution presenting:
a minimum magnetic domain size strictly greater than the minimum magnetic domain size of the first statistical distribution and;
for a given area, magnetic domains in which the perimeter is greater than that of domains from the first statistical distribution.

According to the third step 3, on the first ferri, ferro, para or diamagnetic layer in which the magnetic domains are modified, an antiferromagnetic layer is caused to grow of a material in which at least one of the components of the material of the first layer may be integrated by diffusion during growth; This second antiferromagnetic layer, that may advantageously be of the same chemical composition as the first layer, forms a magnetic structure in which the Néel domains repeat the shape and dimensions of the Weiss domains of the first layer.

According to a preferential embodiment of the invention, the material utilized for the first layer is a ferrimagnetic material; the invention finds a particularly interesting application in the case of the ferrimagnetic γ-Fe₂O₃ material.

According to a first embodiment of the process according to the invention, the first layer (initial layer) is deposited in a thin film on a substrate in an environment that is free from contamination and without chemical reaction facing the deposited material, preferably under ultra-high vacuum (typically a residual vacuum of less than 10⁻⁹ mbar).

In the case of Fe₂O₃, a substrate of α-Al₂O₃(0001) or Pt(111) and a growth chamber with a residual vacuum of 5.10⁻¹⁰ mbar may be utilized. The Pt substrate prevents the presence of charge effects for certain measures. The growth of Fe₂O₃ films is carried out on a substrate cleaned of any contamination by using atomic oxygen plasma and Fe atom evaporation from an MBE (Molecular Beam Epitaxy) source. The evaporants have a high purity (99.999% for the Fe here) and are evaporated with flux on the order of 0.1 nm/min. The pressure during deposition remains better than 10⁻⁸ mbar for an oxygen plasma source that dissociates approximately 10% of the oxygen atoms. The Fe₂O₃ layer may be made in a wide temperature range going from ambient temperature up to 450° C.

As mentioned above, at an early stage of growth, for a thickness such that the ferrimagnetic order is established (γ-Fe₂O₃) but not yet the antiferromagnetic order (α-Fe₂O₃), a saturating magnetic field is applied. In the example given above, the growth was stopped for a thickness of 2 nm and the sample was subjected to magnetic induction of 2 Tesla for 30 seconds with a high field strength speed on the order of 5 minutes and a low field strength also on the order of 5 minutes. The magnetic field may be applied in any direction but a particularly effective result in magnetic anisotropy will be obtained when it is applied in an easy magnetization direction, in particular for materials presenting high magnetocrystalline anisotropy. For γ-Fe₂O₃, this magnetocrystalline anisotropy is weak; Consequently, the orientation of the sample could be any orientation. As we will see, application of the magnetic field enables the statistical distribution of magnetic domains to be modified.

The growth is then continued up to a sufficient thickness so that the antiferromagnetic order is established to carry out the growth of an antiferromagnetic layer (second layer) of α-Fe₂O₃. The final thickness may be chosen according to the application, the remaining antiferromagnetic domains are subsequently fixed.

For the material cited as an example, thicknesses up to 30 nm have been tested.

The result of this process is illustrated by FIG. 5 that represents the statistical evolution of the perimeter of magnetic domains according to the area of these domains for two antiferromagnetic layers of α-Fe₂O₃ with a thickness of 10 nm obtained respectively with and without magnetic field treatment in the early phase (after establishment of the ferrimagnetic order) of the growth.

The round dots relate to a layer directly deposited in a magnetic field. The square dots relate to a layer of Fe₂O₃ obtained by the process according to the invention whose growth has been stopped for a thickness of 2 nm where magnetic induction of 2 Tesla has been applied for 30 seconds with a high and low field strength speed on the order of 5 min. The growth was then continued up to a thickness of 10 nm.

It is observed that the statistical universality class of the second curve is kept but this second curb is vertically displaced and the smallest domains have been eliminated. In other words, two effects linked to the magnetic field application are observed:
for a given area, the perimeter of the magnetic domains is increased;
the low part of the curve corresponding to reduced size domains is eliminated.

In the example illustrated in FIG. 5, the statistical distribution of antiferromagnetic domains is modified such that the perimeter of magnetic domains for a given area is multiplied by a factor close to 3. The effect may be adjusted according to the intensity of the field applied (depending on whether it is saturating or not for the material) or the characteristics of the materials (particularly the coercive field strength and the magnetocrystalline anisotropy of the material).

This double effect that consists not only of eliminating the smallest domains but also of increasing already large domains is explained by the fact that the antiferromagnetic layer repeats the statistical distribution of the domains of the ferrimagnetic layer on which it grows; Consequently, by acting on the statistical distribution of ferrimagnetic layer domains, the statistical distribution of antiferromagnetic layer domains is acted on. The statistical distribution in α-Fe₂O₃ is thus modified when a magnetic field is applied to γ-Fe₂O₃ before finishing the growth, this modification being attainable without requiring thermal treatment. In other words, the antiferromagnetic state of the α-Fe₂O₃ layer is modified by applying a magnetic field before the transition to the antiferromagnetic order. Thus, the size, shape or statistical distribution of the antiferromagnetic domains may be controlled without resorting to thermal annealings or post-processing methods. By using this process, a specific magnetic anisotropy may be “imprinted” in the antiferromagnetic material thanks to the action of a magnetic field in the early phase that exists for a thickness of less than the appearance of the antiferromagnetic order. According to the preferential embodiment where a magnetic field is applied for the time necessary for shifting domains, the fields to be applied will typically be on the order of 0.01 Tesla for times of at least some milliseconds.

Of course, the process according to the invention applies to other materials such as Fe₂O₃. Thus, FIG. 6 represents the statistical evolution of the perimeter of magnetic domains according to the area of these domains for different antiferromagnetic layers of Fe₂O₃ (round dots) and an antiferromagnetic layer of LaFeO₃ (square dots) with a thickness of 40 nm. It is observed that the distribution of domains for another antiferromagnetic compound, that is LaFeO₃, follows the same statistical laws as Fe₂O₃, (again the random field Ising model characterized by a fractal dimension of 1.9±0.02 and a roughness coefficient of 0.58±0.04). It will be noted in addition that the layers of LaFeO₃ from which the images have been processed and compared for obtaining the statistical distribution have been deposited on substrates of SrTiO₃(001) by laser ablation pulsed under a partial oxygen pressure of 10⁻⁴ mbar and for a substrate temperature of 1300° C. This process of obtaining is thus radically different from the process of obtaining layers of Fe₂O₃ (significant partial O₂ pressure and very rapid process in the case of LaFeO₃ and very little O₂ and slower reaction in the case of Fe₂O₃). The observations of antiferromagnetic domains thus do not depend on the manner of preparing the antiferromagnetic layers. Other growth methods, for example by chemical means (of the CVD chemical vapor phase or electrochemistry type) may also be utilized, the only condition being to start with an antiferromagnetic material from a material having a different magnetic order (here typically a ferrimagnetic order).

Of course, the process according to the invention is not limited to the embodiments that have just been described for indicative and in no way limiting purposes with reference to FIGS. 1 to 6.

In particular, the invention was more particularly described in the case of a first ferrimagnetic layer; As we have already mentioned, as the ferro and ferrimagnetic properties of the layers are very close, the invention also applies to an initial ferromagnetic layer. In addition, the process is also applicable to first paramagnetic or diamagnetic initial layers. Thus, by way of example, a critical nanometric size exists for which particles of Ni—Mn transit from a paramagnetic order to an antiferromagnetic order [see in particular Ladwig et al. Journal of Electronic Materials 32 (2003) pp 1155-1159]; Implementing the process with an initial (first layer) paramagnetic layer of Ni—Mn that transits to a second antiferromagnetic layer of Ni—Mn may thus be considered. Moreover, thin films of Cr are often diamagnetic while bulk chromium adopts an antiferromagnetic order [see in particular K. Schrôder and S, Nayak, Physica Status Solidi (b) 172 (1992) pp 679-686]. Implementing the process with an initial (first layer) diamagnetic layer of Cr and a second antiferromagnetic layer of Cr may thus also be considered.

As with the process described previously, a specific magnetic anisotropy may be “imprinted” in the antiferromagnetic material thanks to the action of a magnetic field in the early phase that exists for a thickness of less than the appearance of the antiferromagnetic order. For paramagnetic or diamagnetic initial layers, the application of the magnetic field is done until the thickness is sufficient so that the antiferromagnetic order is established. For an early paramagnetic phase, a moderate field of some 0.01 T to some 0.1 T will be sufficient. In the case of the utilization of a first diamagnetic layer, the limited magnetic susceptibility of the diamagnetic materials requires applying higher amplitude magnetic fields to influence the latter, typically from 1 to several Tesla, or even more.

In addition, in the example described, the growth was stopped and the sample was taken out of the growth chamber to be subjected to a magnetic field. Of course, it is also possible to apply the magnetic field directly in the growth chamber. By designating the term “magnetic means” to refer to the assembly of devices enabling a magnetic field to be applied at the location where the MBE (or other) deposition will be carried out, these magnetic means may be constituted either by at least one permanent magnet or by at least one vacuum coil arranged directly in the chamber.

The process according to the invention finds an immediate application in spin electronics, also designated by the term spintronics. Spintronics is a growing discipline that consists of utilizing the spin of the electron as an additional degree of freedom with relation to conventional electronics on silicon that only utilize its charge. In fact, spin has a significant effect on the transport properties in ferromagnetic materials. Many spintronics applications, in particular memories or logic elements, utilize stacks of magnetoresistive layers comprising at least two ferromagnetic layers separated by a non-magnetic layer. One of the ferromagnetic layers is trapped in a fixed direction and acts as a reference layer while the magnetization of the other layer may be switched relatively easily by the application of a magnetic moment by a magnetic field or a spin polarized current.

These stacks may be magnetic tunnel junctions when the spacer layer is insulating or structures known as spin valves when the spacer layer is metallic. In these structures, the resistance varies according to the relative orientation of magnetizations of the two ferromagnetic layers.

As we have already mentioned, the magnetization of one of these ferromagnetic layers (called hard layer, HL) is fixed. The stability of this layer may be ensured by its shape and/or by exchange coupling with an antiferromagnetic layer. This exchange coupling necessitates the deposition of a ferromagnetic layer on an antiferromagnetic layer, the latter may be an antiferromagnetic synthesis layer. Here all the interest of the process according to the invention may be seen since the magnetic jig created via this process may be utilized to propagate in magnetic junction layers of the spin valve or tunnel junctions type. The magnetic domains of the antiferromagnetic layer are in fact also repeated by the ferromagnetic layer that will be grown on it. This phenomenon is illustrated by FIG. 7 that represents:
an image (left) of magnetic domains from a ferromagnetic layer of 2 nm of Co deposited on an antiferromagnetic layer of Fe₂O₃ with a thickness of 20 nm obtained by the process according to the invention and;
an image (right) of domains from an antiferromagnetic layer of Fe₂O₃ with a thickness of 20 nm obtained by the process according to the invention.

The images are made by spectromicroscopy from a source of circularly polarized monoenergetic photons with energy close to absorption thresholds L2 or L3 of Co for the left image and Fe for the right image; The image results from the weighted difference of images observed for horizontal and vertical linear polarizations for observation of antiferromagnetic domains and circularly left and right polarizations for observation of ferromagnetic domains. The direction of incident photons is indicated by an arrow in the image. For the image of the antiferromagnetic layer, the white zones represent the magnetic domains with magnetic moments parallel or antiparallel to the direction of incident photons (represented by a double black arrow). The grey or black zones represent magnetic domains with magnetic moments substantially perpendicular to the direction of the incident photons (represented by a double white arrow). For the image of the ferromagnetic layer, the black zones represent magnetic domains with magnetic moments opposed to the direction of the incident photons (represented by a white arrow). The white zones represent magnetic domains in which the direction of magnetic moments is situated following the direction of the incident photons (represented by a black arrow).

As may be observed in these two images, the Co layer reproduces the same magnetic domain configuration as the underlying antiferromagnetic layer of Fe₂O₃. Thus, with a magnetic field that is sufficiently intense during the early phase, it is completely possible to obtain monodomain layers (or in any case, to eliminate reduced size domains and to increase the size of the remaining domains) in order to reduce the noise linked to reduced size magnetic domains. The process according to the invention opens the way to spintronics applications allowing the utilization of antiferromagnetic materials with a high Néel temperature (this is particularly the case with Fe₂O₃ whose Néel temperature is about equal to 650° C.) and the utilization of ferromagnetic materials with lower Curie temperatures (free from the requirement for a high Curie temperature via the absence of thermal treatment). In the case of an application aiming to obtain larger size domains (or even a monodomain), macroscopic magnetic anisotropy is imprinted to the assembly of materials utilized by using a macroscopic magnetic field. However, it will be noted that it is also possible to utilize a magnetic field that is applied locally, for example via an MFM (Magnetic Force Microscopy) tip, by patterning magnetic domains and by thus creating a jig in domain form and by then depositing the ferromagnetic material on the antiferromagnetic layer obtained by the process according to the invention, for example for the development of magnetic sensors of the spin valve or tunnel junction type that will return to the form of domains impregnated at the start in the initial ferrimagnetic layer.

1. A process for fabricating an antiferromagnetic layer comprising:
depositing on a substrate a first layer with a sufficient thickness to establish a specific magnetic order from among one of the following orders,
ferrimagnetic,
ferromagnetic,
paramagnetic,
diamagnetic;
after establishing said ferrimagnetic, ferromagnetic, paramagnetic or diamagnetic order, applying a magnetic field with sufficient amplitude and duration to shift walls of the magnetic domains of said first layer from a first statistical distribution to a second statistical distribution, said second statistical distribution presenting:
a minimum magnetic domain size strictly greater than the minimum magnetic domain size of the first statistical distribution and;
for a given area, magnetic domains in which the perimeter is greater than that of domains from said first statistical distribution; and
depositing on said first layer whose magnetic domain walls have been shifted, a second layer of an antiferromagnetic material in which at least one of the components of material of said first layer may be integrated by diffusion during growth.

2. The process according to claim 1, wherein the magnetic field is applied for a time at least equal to that required for the specified switching of said magnetic domains.

3. The process according to claim 1, wherein the antiferromagnetic material of said second layer has the same chemical formula as that of the material from said first layer.

4. The process according to claim 1, wherein said first layer is a ferrimagnetic or ferromagnetic layer, and a time of said magnetic field application is at least equal to the time necessary to switch said domains.

5. The process according to claim 1, wherein said first layer is made in a ferrimagnetic γ-Fe₂O₃ material such that the antiferromagnetic state of said second layer of α-Fe₂O₃ is modified by applying a magnetic field on said first layer before the transition to the antiferromagnetic order.

6. The process according to claim 1, wherein said first layer is a paramagnetic or diamagnetic layer, and wherein the magnetic field is applied for a time greater than or equal to the time necessary for reestablishing the antiferromagnetic order of said second layer.

7. The process according to claim 1, wherein said magnetic field is applied after a thickness of said first layer is greater than or equal to the thickness necessary so that the magnetic order of said first layer is established.

8. The process according to claim 1, wherein said magnetic field is applied after a thickness of said first layer is greater than or equal to a thickness on the order of two to three atomic layers.

9. The process according to claim 1, wherein said magnetic field is applied according to a direction parallel to a crystalline anisotropy axis of the material of said first layer.

10. The process according to claim 1, wherein said magnetic field application is done outside of a deposition chamber in which said process is implemented.

11. The process according to claim 1, wherein said magnetic field application is done inside a chamber in which said process is implemented via magnetic means such as at least one permanent magnet or at least one vacuum coil arranged directly in said chamber.

12. The process according to claim 1, wherein the deposition of said first and second layers is done in a growth chamber by molecular beam epitaxy with a pressure, during the deposition, of less than or equal to 10⁻⁸ bar and preferentially of less than or equal to 10⁻⁹ bar.

13. The process according to claim 12, wherein a deposition temperature of said first and second layers is between ambient temperature and 450° C.

14. The process according to claim 1, wherein said first layer is grown on a substrate cleaned of any contamination.

15. The process according to claim 1, wherein the deposition of said first and second layers is done by utilizing one of the following techniques:
deposition by laser ablation;
molecular beam epitaxy;
deposition by chemical means such as chemical deposition in CVD vapor phase or electrochemistry.

16. The process according to claim 1, wherein said substrate is an Al₂O₃(0001) or Pt(111) type substrate.

17. The process according to claim 1, wherein said magnetic field applied is a field sufficient for causing the shifting of magnetic walls and is limited at most to the saturating field value for the material of said first layer.

18. The process according to claim 1, wherein said magnetic field is not uniform in space and presents at least one first region subjected to a first magnetic field value uniform in intensity and direction, and at least one other magnetic field value uniform in intensity and direction, creating a structuring of the space in magnetically distinct zones.

19. A magnetic structure comprising at least one antiferromagnetic layer obtained by the process according to claim 1.

20. The magnetic structure according to claim 19, wherein the structure comprises at least one ferromagnetic layer deposited on said antiferromagnetic layer and in which the configuration of magnetic domains is identical to that of said antiferromagnetic layer.
